(19) United States
(12) Patent Application Publication
(10) Pub. No.: US 2016/0102978 A1
(43) Pub. Date: Apr. 14, 2016

(54) ROTATION VELOCITY SENSOR AND METHOD FOR SENSING ROTATION VELOCITY

(71) Applicant: RICHTEK TECHNOLOGY CORPORATION, Zhubei City (TW)

(72) Inventors: Lupu Liao, Taipei (TW); Chiung-C. Lo, Zhunan Township (TW); Ying-Che Lo, Tainan (TW)

(21) Appl. No.: 14/880,527

(22) Filed: Oct. 12, 2015

Related U.S. Application Data
(60) Provisional application No. 62/063,529, filed on Oct. 14, 2014.

(51) Int. Cl. G01C 19/56

(52) U.S. Cl. CPC G01C 19/56

(57) ABSTRACT

A rotation velocity sensor includes a driving unit, a proof mass, a rotation sensing element, a compensating unit, and a rotation sensing unit. The driving unit generates a vibration driving signal and a reference signal. The proof mass is driven by the vibration driving signal to vibrate in a first direction. The rotation sensing element senses a vibration of the proof mass to generate a charge signal which corresponds to a portion of the vibration of the proof mass in a second direction orthogonal to the first direction. The compensating unit generates a compensation signal according to the reference signal. The rotation sensing unit converts the charge signal to a voltage signal or a current signal, and compensates the voltage signal or the current signal according to the compensation signal to cancel a noise in the second direction.

### CROSS REFERENCE

The present invention claims priority to U.S. 62/063,529, filed on Oct. 14, 2014.

### BACKGROUND OF THE INVENTION

1. Field of Invention

The present invention relates to a rotation velocity sensor, which senses a vibration of a proof mass to generate a charge signal, converts the charge signal into a voltage signal or a current signal, and compensates the voltage signal or the current signal according to a compensation signal to cancel a quadrature error.

2. Description of Related Art

A MEMS rotation velocity sensor for sensing a rotation velocity is usually prone to have a quadrature error, which is caused by an unbalanced vibration of a proof mass. The vibration of the proof mass generates a charge signal, but due to this unbalanced vibration, the charge signal carries information not only about the rotation velocity but also including the quadrature error, rendering the readout incorrect. The information about the rotation velocity (rotation sensing signal) and the quadrature error are in the same frequency but with a phase difference in between.

In order to cancel the quadrature error, U.S. Pat. No. 7,290,435 provides a rotation velocity sensor 10, as shown in FIG. 1, which includes a proof mass, a driving unit providing a vibration driving signal driving the proof mass to vibrate, a sense mass sensing the vibration of the proof mass to generate a charge signal, a quadrature error cancellation unit generating a compensation signal according to the driving signal to cancel the quadrature error in the charge signal, and a sense mass position sensing unit generating a rotation sensing signal according to the compensated charge signal. The charge signal and the compensation signal are both signals in the form of charges, so the compensation operation is uneasy and it is difficult to generate a precise compensation signal to properly cancel the quadrature error in the charge signal.

U.S. Pat. No. 7,213,458 discloses another approach to cancel the quadrature error. This prior art applies an electrostatic force on the proof mass to counter its quadrature motion. That is, this prior art cancels the quadrature error by compensating the motion of the proof mass. This type of approach requires complicated motion control and extra electrodes. Similar approaches are also proposed by U.S.

U.S. Pat. Nos. 7,051,590, 7,032,451, and a paper titled “Quadrature-Error Compensation and Corresponding Effects on the Performance of Fully Decoupled MEMS Gyroscopes” (Journal of Microelectromechanical Systems. Vol. 21, Issue 3, 2012) issued by Tatar, E, which have the same drawbacks.

U.S. Pat. Nos. 7,290,435, and 6,571,630 disclose another approach to cancel the quadrature error by process trimming, i.e., this type of prior art trims (removes an unbalanced structure portion of) the MEMS device in a manufacturing process, so that the MEMS device is exactly the shape that is desired, and the vibration of the proof mass does not generate a quadrature error. However, it is difficult to precisely correlate the structure to the quadrature error, and the quadrature error may come from sources other than the structure. This type of approach is complicated and the compensation result is not satisfactory.

### SUMMARY OF THE INVENTION

In one perspective, the present invention provides a rotation velocity sensor, comprising: a driving unit, is configured to operably generate a vibration driving signal in a predetermined frequency, and generate a reference signal in a same phase of the vibration driving signal; a proof mass, configured to be operably driven by the vibration driving signal to vibrate in a first direction; a rotation sensing element, configured to operably sense a vibration of the proof mass to generate a charge signal which corresponds to a portion of the vibration of the proof mass in a second direction orthogonal to the first direction; a compensating unit, is configured to operably generate a compensation signal according to the reference signal; and a rotation sensing unit, configured to operably convert the charge signal to a voltage signal or a current signal, and compensate the voltage signal or the current signal according to the compensation signal to cancel a noise in the second direction so as to obtain a compensated rotation sensing signal.

In one embodiment, the charge signal includes information about a rotation of the sensor and a quadrature error, and at least a portion of the quadrature error is canceled in the compensated rotation sensing signal.

In one embodiment, the reference signal is related to the vibration driving signal.

In one embodiment, the compensating unit is configured to operably generate the compensation signal according to the reference signal and a disturbance detection signal, wherein the disturbance detection signal indicates a noise other than a quadrature error.

In one embodiment, the rotation sensing unit includes: a charge-to-voltage (C/V) or a charge-to-current (C/I) converter, configured to operably convert the charge signal to the voltage signal or the current signal; a compensation operator, configured to operably compensate the voltage signal or the current signal by the compensation signal to generate a compensated voltage or current signal; and a demodulator, configured to operably demodulate the compensated voltage or current signal to generate a demodulated signal.

In one embodiment, the compensation operator compensates the voltage signal or the current signal by the compensation signal by an addition or subtraction operation.

In one embodiment, the compensating unit further adjusts a conversion ratio of the charge to voltage or charge to current conversion.

In one embodiment, the rotation sensing unit further includes: an amplifier coupled between the compensation operator and the demodulator, for amplifying the compensated voltage or current signal by a gain.

In one embodiment, the compensating unit further adjusts the gain of the amplifier.

In one embodiment, the rotation sensing unit further includes: a filter for filtering the demodulated signal.

In one embodiment, the rotation sensing unit outputs the compensated rotation sensing signal in an analog or a digital form.

In one embodiment, each of the reference signal, the compensation signal, the charge signal, the voltage signal or the current signal, and the compensated rotation sensing signal includes a pair of differential signals.

In one embodiment, the differential signals of the charge signal are separately converted to the differential signals of the voltage signal or the current signal, and separately compensated by the differential signals of the compensation signal.

In another perspective, the present invention provides a method for sensing a rotation velocity, comprising: driving a proof mass by a vibration driving signal such that the proof mass vibrates in a first direction; sensing a vibration of the proof mass to generate a charge signal which corresponds to a portion of the vibration of the proof mass in a second direction orthogonal to the first direction; generating a compensation signal according to the vibration driving signal; converting the charge signal to a voltage signal or a current signal; and compensating the voltage signal or the current signal according to the compensation signal to cancel a noise in the second direction so as to obtain a compensated rotation sensing signal.

In one embodiment, the step of generating a compensation signal according to the vibration driving signal generates the compensation signal according to the reference signal and a disturbance detection signal, wherein the disturbance detection signal indicates a noise other than a quadrature error.

In one perspective, the present invention provides the step of compensating the voltage signal or the current signal according to the compensation signal includes: compensating the voltage signal or the current signal by the compensation signal by an addition or subtraction operation.

In one embodiment, the method further includes: adjusting a conversion ratio of the charge to voltage or charge to current conversion.

In one embodiment, the method further includes: amplifying the voltage signal or the current signal by a gain; and adjusting the gain.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art rotation velocity sensor.

FIG. 2 shows a rotation velocity sensor according to one embodiment of the present invention.

FIG. 3 shows a rotation sensing element according to one embodiment of the present invention.

FIG. 4A-4C show embodiments of a rotation sensing unit according the present invention.

FIGS. 5, 6, and 7 show several embodiments of the rotation velocity sensors according to the present invention.

FIG. 8 shows a portion of a rotation sensing unit according to another embodiment of the present invention.

FIGS. 9A-9B illustrate embodiments of the converter C/V or C/I.

FIG. 10 shows a rotation sensing unit according to yet another embodiment of the present invention.

FIG. 11 shows a flowchart of a method for sensing rotation velocity according to yet another embodiment of the present invention.

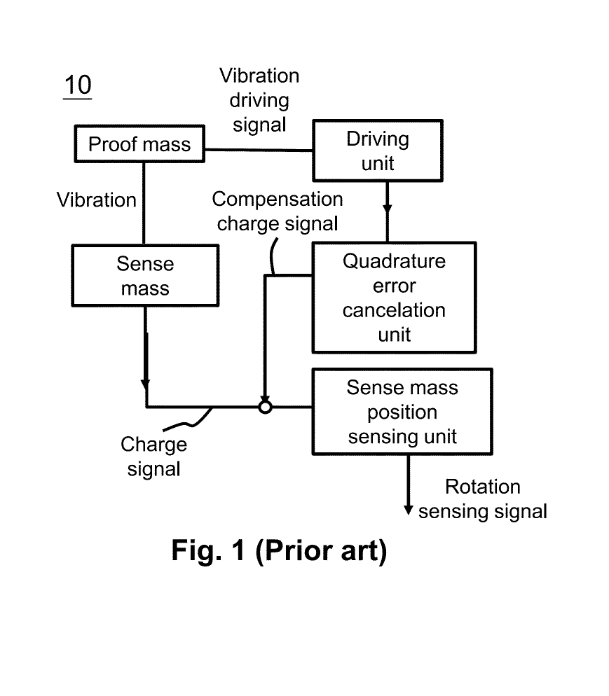

### DESCRIPTION OF THE PREFERRED EMBODIMENTS

The drawings as referred to throughout the description of the present invention are for illustrative purpose only, to show the interrelations between the circuits and/or devices, but not drawn according to actual scale.

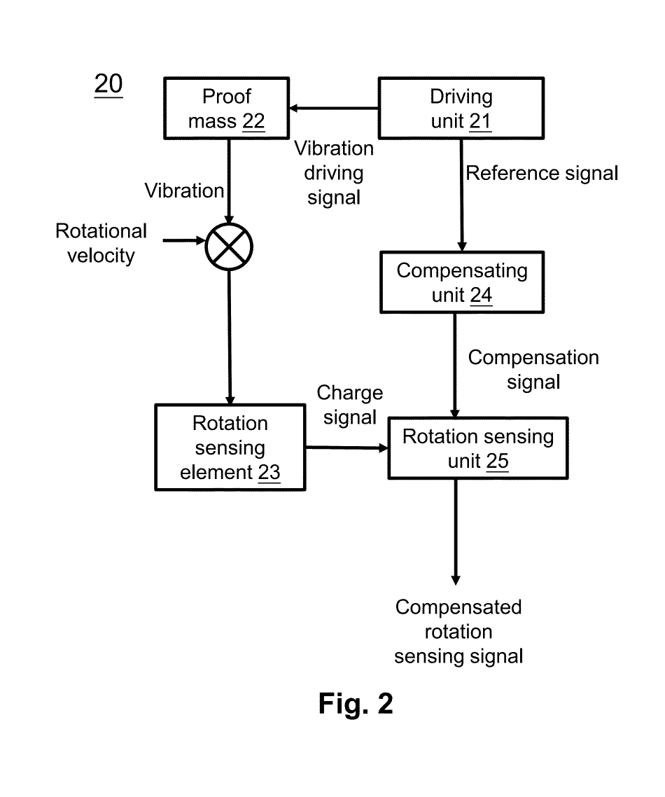

FIG. 2 shows a rotation velocity sensor 20 according to one embodiment of the present invention. The rotation velocity sensor 20 includes: a driving unit 21, a proof mass 22, a rotation sensing element 23, a compensating unit 24, and a rotation sensing unit 25. The driving unit 21 generates a vibration driving signal in a predetermined frequency and a reference signal in a same phase of the vibration driving signal. The reference signal can be the vibration driving signal itself, a signal that is generated from the vibration driving signal, or a signal that the driving unit 21 generates separately from the vibration driving signal but is related to the vibration driving signal. The proof mass 22 is driven by the vibration driving signal to vibrate in a first direction. When the rotation velocity sensor 20 is subject to a rotational velocity, the rotation sensing element 23 senses the vibration of the proof mass to generate a charge signal which corresponds to a portion of the vibration of the proof mass in a second direction, and the second direction is orthogonal to the first direction. The charge signal includes the information about the rotation of the rotation velocity sensor 20, and possibly further includes a noise such as a quadrature error.

The rotation sensing unit 25 converts the charge signal into a voltage signal or a current signal. The compensating unit 24 generates a compensation signal according to the reference signal; the compensation signal is also a voltage signal or a current signal. For example, the reference signal is a voltage signal, and it can be amplified with a gain ratio to generate the compensation signal, or it can be converted into a current signal. The rotation sensing unit 25 compensates the voltage signal or the current signal converted from the charge signal by the compensation signal (which is in the same voltage or current form as the voltage or current signal converted from the charge signal), to generate a compensated rotation sensing signal corresponding to the portion of the vibration of the proof mass 22 in the second direction. In one embodiment, the compensated rotation sensing signal corresponds to a Coriolis acceleration of the proof mass 22 in the second direction, wherein at least a significant part of the quadrature error is cancelled.

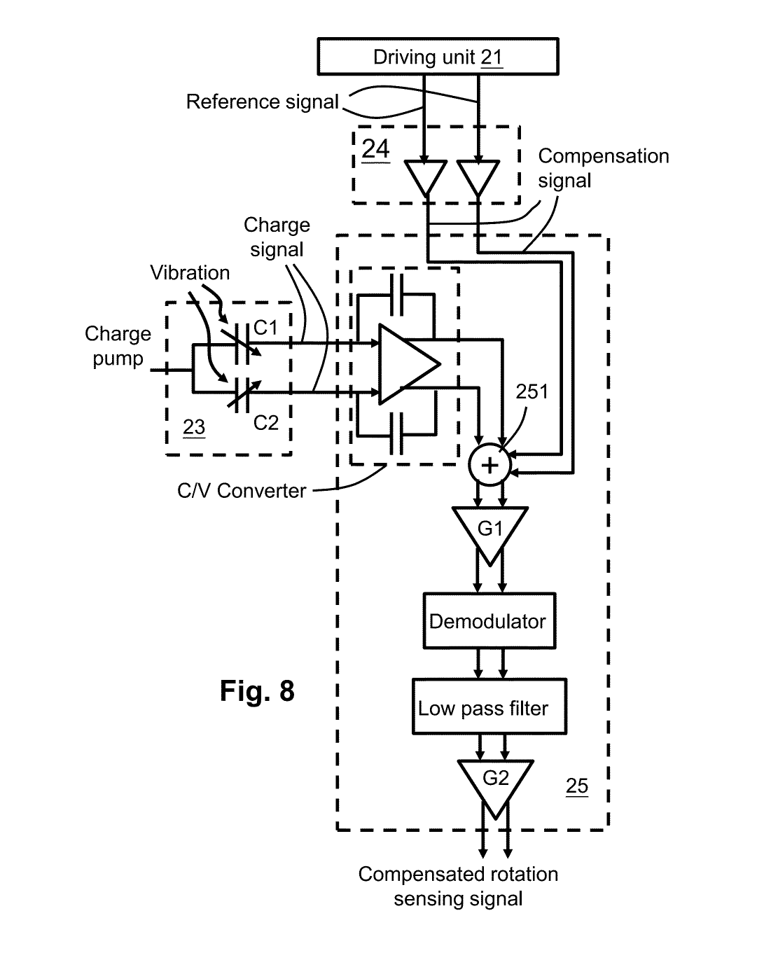

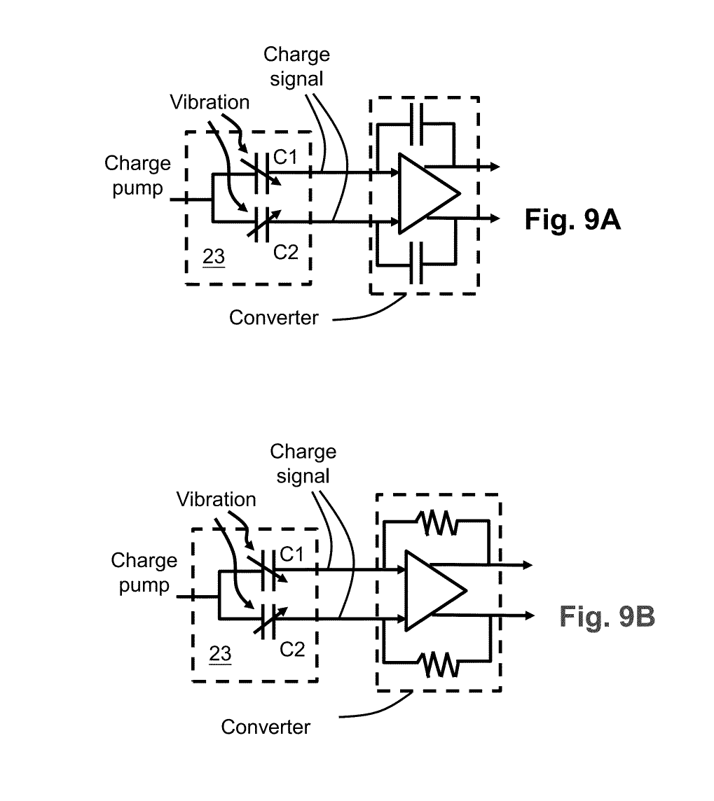

In comparison with the prior art U.S. Pat. No. 7,290,435, the compensation operation of the present invention is much easier, because the compensation operation is performed between two voltage or two current signals. In U.S. Pat. No. 7,290,435, the compensation operation is between two charge signals. To realize a circuit for adding one charge signal to another or to subtract one charge signal from another is relatively more difficult than to realize a circuit for adding one voltage (or current) signal to another or to subtract one voltage (or current) signal from another. This important difference can be more clearly understood with reference to FIGS. 8 and 9A-9B and will be explained later.

In comparison with the other prior art patents, the present invention does not require a complicated motion control, extra electrodes, or an extra trimming step in the manufacturing process.

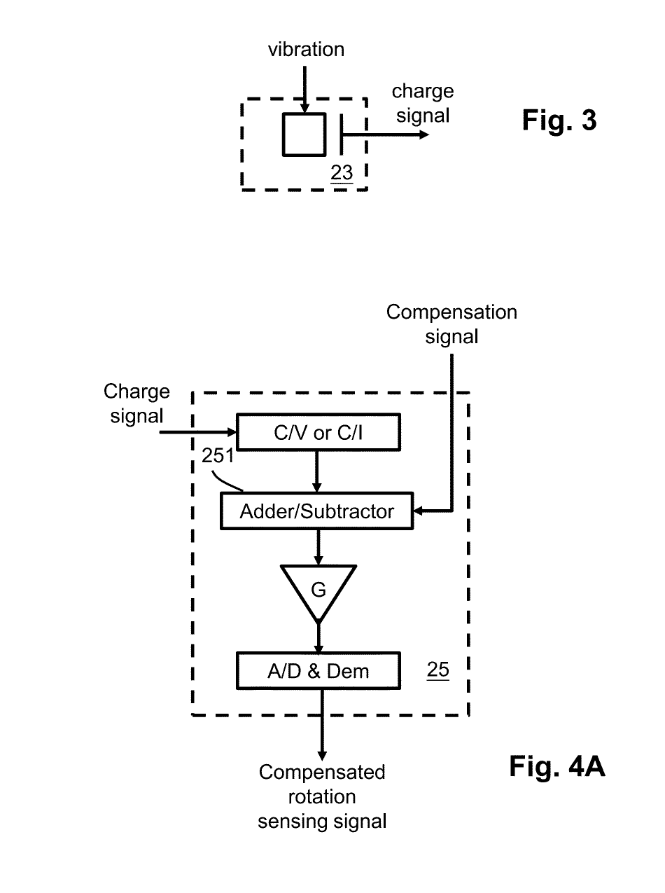

FIG. 3 shows an embodiment of the rotation sensing element 23. A typical example of a rotation sensing element is a Coriolis sensing element, which senses a vibration and generates a charge signal.

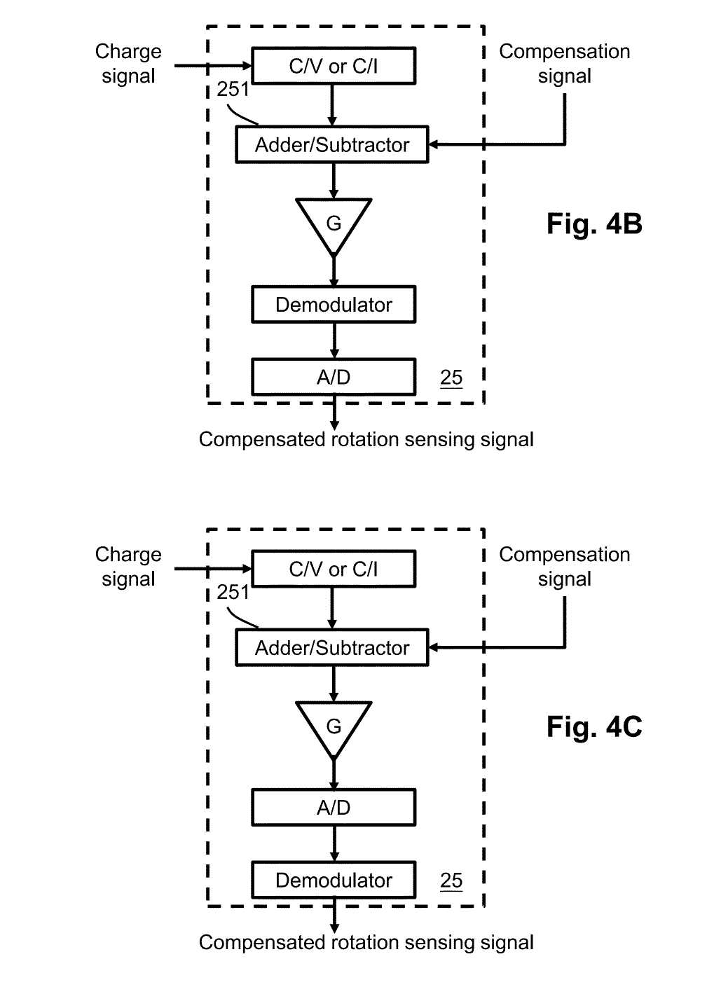

FIG. 4A shows a rotation sensing unit 25 according to one preferable embodiment of the present invention. The rotation sensing unit 25 includes: a charge-to-voltage or a charge-to-current converter C/V or C/I, a compensation operator 251, an amplifier G, and a processing unit A/D & Dem. The charge-to-voltage or a charge-to-current converter C/V or C/I converts the charge signal generated by the rotation sensing element 23 to a voltage or a current signal, and the compensation operator 251 compensates the voltage or current signal by the compensation signal to cancel the quadrature error. The compensation operator 251 adds the compensation signal to or subtract the compensation signal from the output of the converter C/V or C/I to generate a compensated voltage or current signal. The amplifier G amplifies the compensated voltage or current signal by a gain. The processing unit A/D & Dem includes an A/D (analog-to-digital) converter and a demodulator. The demodulator demodulates the compensated voltage or current signal to obtain the rotation information (the compensated rotation sensing signal), and the A/D converter converts the demodulated signal to a digital form (as shown in FIG. 4B); or, the A/D converter converts the compensated voltage or current signal to a digital form and demodulator demodulates the voltage or current signal in digital form to obtain the rotation information (the compensated rotation sensing signal) (as shown in FIG. 4C).

In the above embodiment, the amplifier G and the A/D converter are preferred but not necessarily required. The compensated rotation sensing signal can be outputted in an analog form.

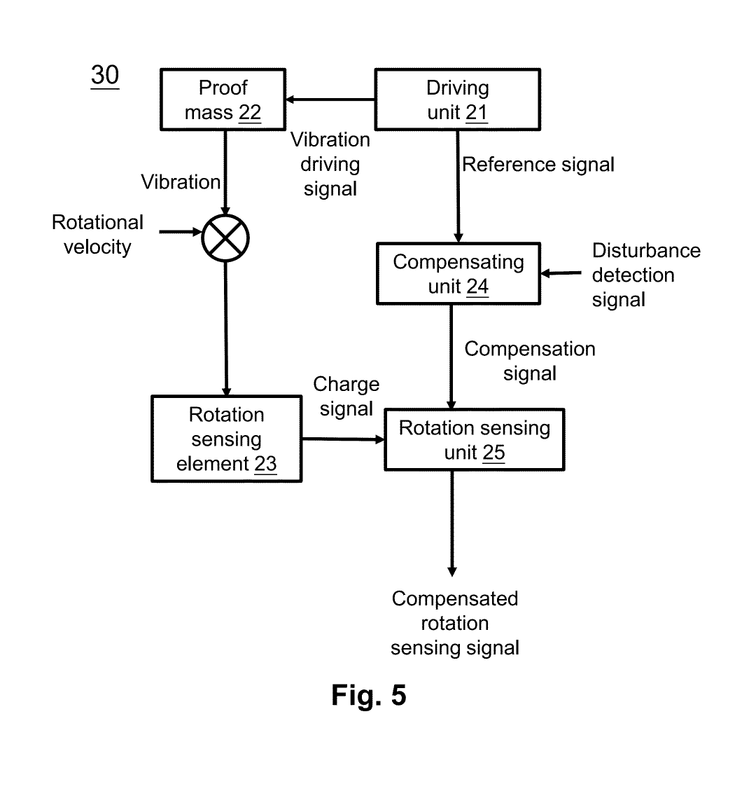

FIG. 5 shows a rotation velocity sensor 30 according to another embodiment of the present invention, wherein the compensating unit 24 generates the compensation signal according to the reference signal and a disturbance detection signal. A disturbance detection unit (not shown), external or internal to rotation velocity sensor 30, generates the disturbance detection signal. The disturbance detection signal indicates a noise other than the quadrature error. For example, the noise may relate to temperature, pressure, stress, undesired magnetic force, etc. The compensation signal can integrate information about such a noise and the quadrature error, such that at least a significant part of this noise and a significant part of the quadrature error are cancelled in the compensated rotation sensing signal.

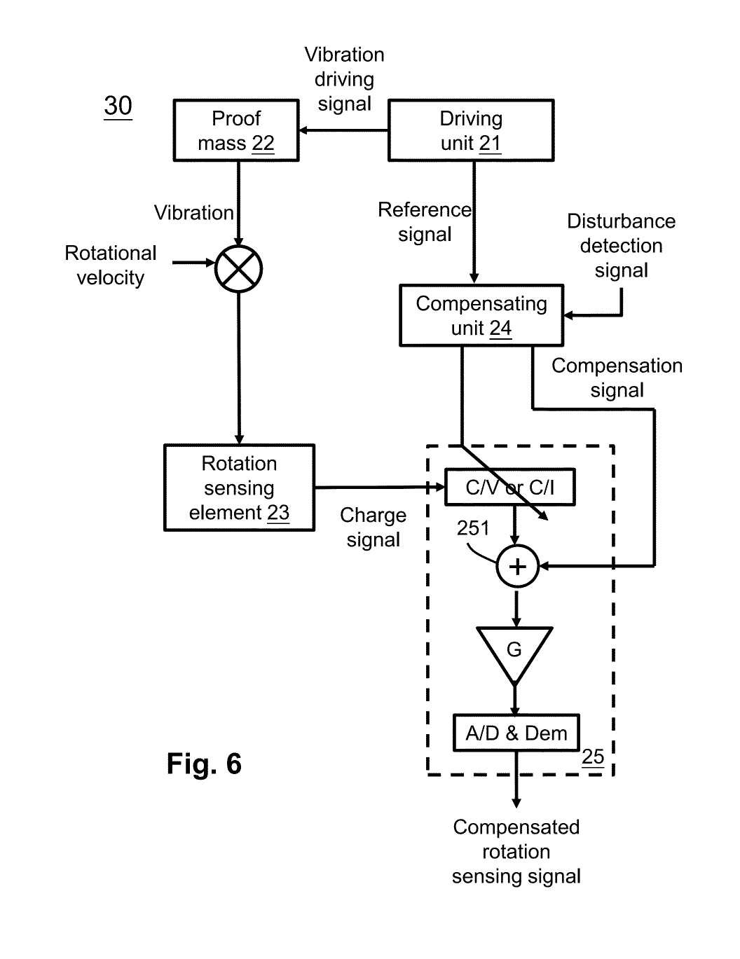

FIG. 6 shows a rotation velocity sensor 40 according to yet another embodiment of the present invention. This embodiment is similar to the embodiment of FIG. 5, but is different in that: the compensating unit 24 not only generates the compensation signal for compensating the voltage or current signal converted from the charge signal, but also adjusts the conversion ratio of the charge to voltage or charge to current conversion. By adjusting the conversion ratio, the quadrature error can be cancelled more accurately.

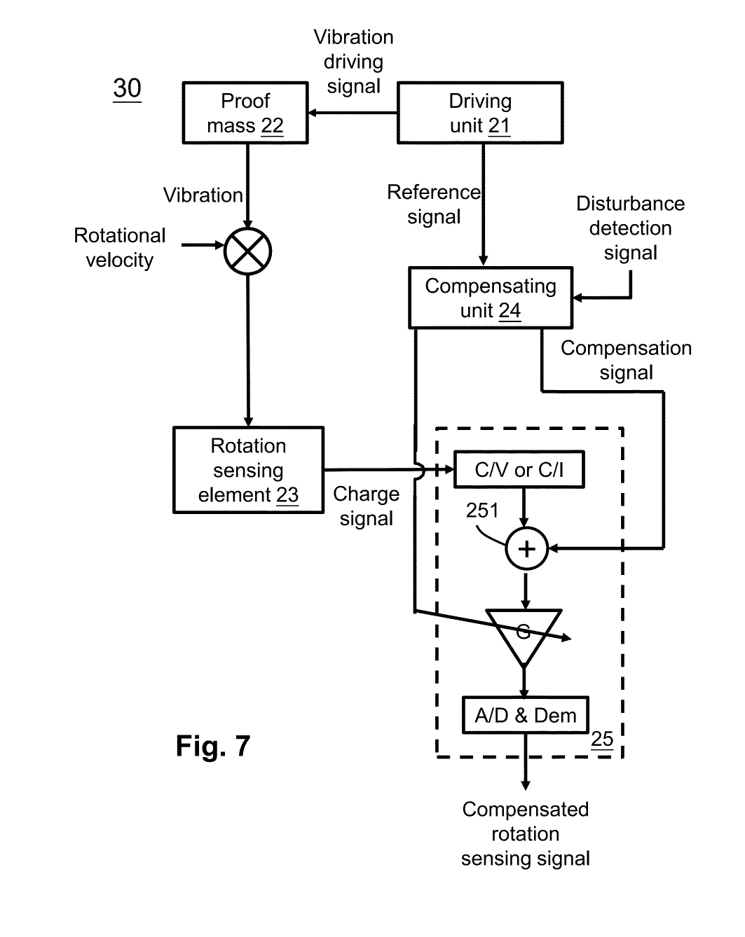

FIG. 7 shows a rotation velocity sensor 50 according to yet another embodiment of the present invention. This embodiment is similar to the embodiment of FIG. 5, but is different in that: the compensating unit 24 not only generates the compensation signal for compensating the voltage or current signal converted from the charge signal, but also adjusts the gain of the amplifier G. in this way, the charge signal generated by the rotation sensing element 23 can be first converted by the converter C/V or C/I with a ratio most suitable for error cancellation, and then the compensated voltage or current signal can be further amplified by a proper gain.

The embodiments of FIGS. 5-7 show that, after the charge signal generated by the rotation sensing element 23 is converted to a voltage or current signal, it can be compensated more easily and accurately; the compensation can be realized by a simpler circuit with better accuracy than the prior art U.S. Pat. No. 7,290,435.

FIG. 8 shows a portion of a rotation velocity sensor according to another preferable embodiment of the present invention, illustrating more specific embodiments of the rotation sensing element 23, the compensating unit 24 and the rotation sensing unit 25. The rotation sensing element 23 includes differential capacitors C1 and C2 charged by a charge pump, and the vibration causes changes of the capacitances of the capacitors which are reflected in the generated charge signals. The compensating unit 24 includes amplifiers generating a differential pair of compensation signals. The rotation sensing unit 25 includes a converter (C/V converter in this embodiment), a compensation operator 251, a first amplifier G1, a demodulator, a low pass filter, and a second amplifier G2 coupled in sequence. The converter converts the charge signals into voltage signals, and the compensation operator 251 performs a compensation operation on the differential pair of charge signals and the differential pair of compensation signals. The compensated differential signals are amplified, demodulated, low-pass filtered, further amplified, and outputted. This embodiment shows that: first, the signals described in the embodiments of FIGS. 2-7 can be differential signals; second, there can be more than one gain stages (amplifiers); third, the signals can be subject to additional processing such as but not limited to a low-pass filtering.

FIG. 8 illustrates that the conversion from charge signals to voltage signals simplifies the quadrature error compensation. A rotation sensing element includes a capacitor charged by a charge pump, and the vibration causes a change of the capacitance of the capacitor which is reflected in the generated charge signal. To compensate the charge signal is to add or subtract another charge signal at the output node of the rotation sensing element, but it is relatively uneasy achieve accurate compensation in this way, because to provide another charge signal requires controlling another variable capacitor. However, in the embodiment of FIG. 8, the C/V converter converts the charge signals outputted by the rotation sensing element 23 to voltage signals. Generating an accurate voltage compensation signal is much easier than controlling a variable capacitor, so accurate compensation becomes easier.

The converter C/V or C/I can be embodied in many forms. FIGS. 9A-9B show two examples. The present invention is not limited to any forms of the C/V and C/I converters.

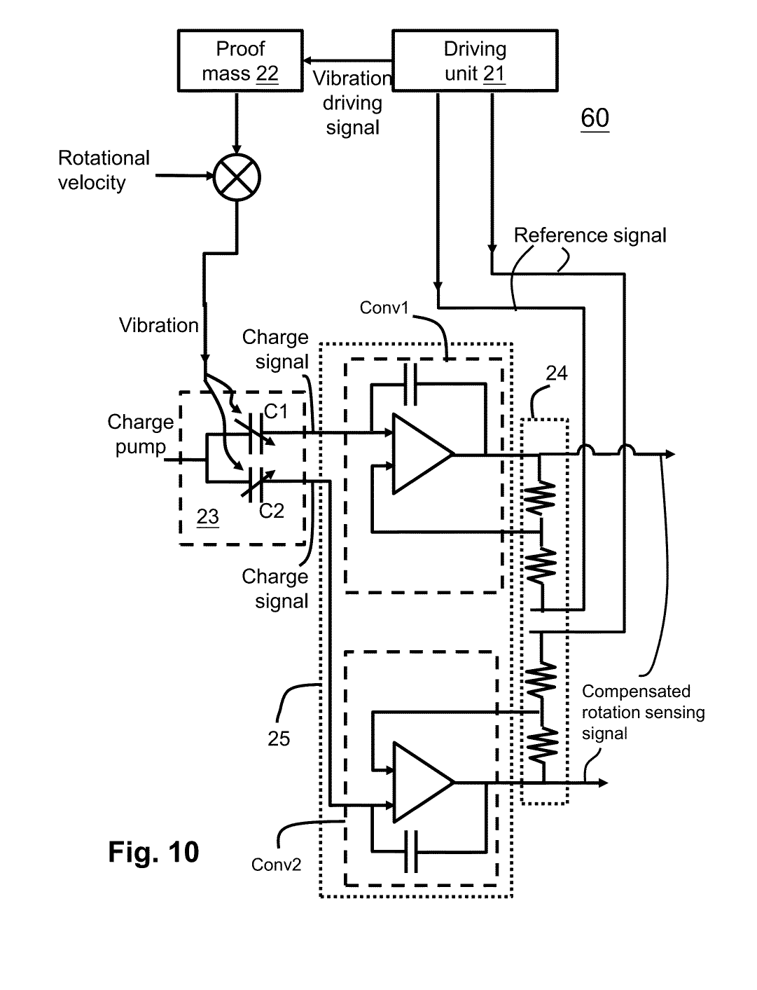

FIG. 10 shows a rotation velocity sensor 60 according to another embodiment of the present invention. In the embodiment of FIG. 8, the differential charge signals are converted by one converter, and the converted differential voltage signals are compensated by differential compensation signals by one compensation operator 251. In the embodiment of FIG. 9, the differential charge signals are separately converted by different converters Conv1 and Conv2, and the converted differential voltage signals are separately compensated by the differential compensation signals. The compensating unit 24 in this embodiment includes voltage divider circuits.

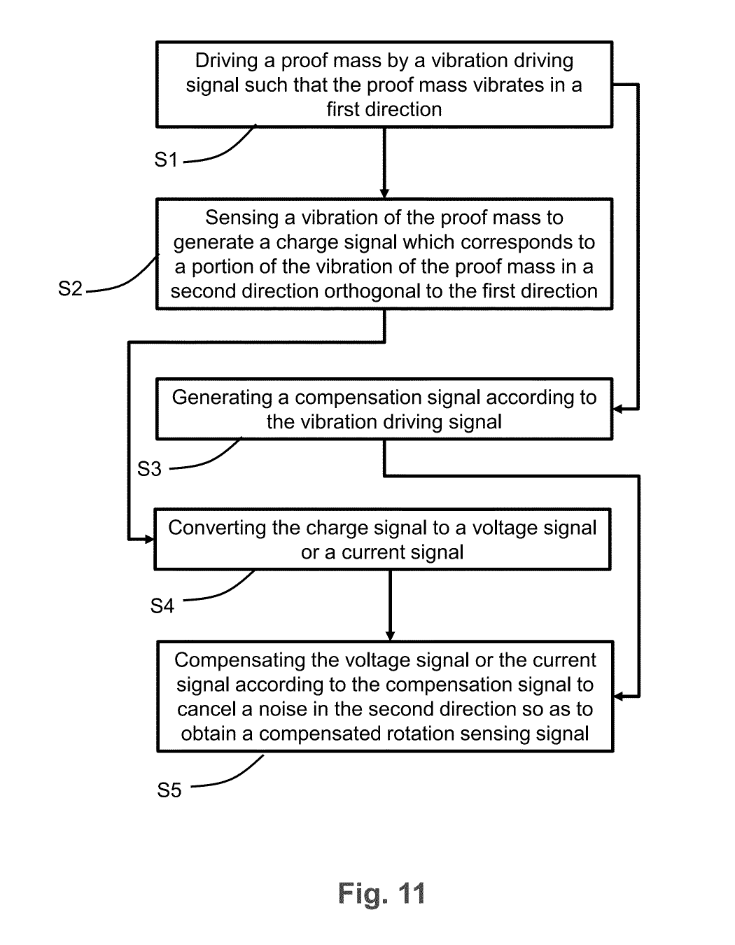

FIG. 11 shows a flowchart of a method for sensing a rotation velocity according to one embodiment of the present invention. The method includes steps of: driving a proof mass by a vibration driving signal such that the proof mass vibrates in a first direction (S1); sensing a vibration of the proof mass to generate a charge signal which corresponds to a portion of the vibration of the proof mass in a second direction orthogonal to the first direction (S2); generating a compensation signal according to the vibration driving signal (S3); converting the charge signal to a voltage signal or a current signal (S4); and compensating the voltage signal or the current signal according to the compensation signal to cancel a noise in the second direction so as to obtain a compensated rotation sensing signal (S5).

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. Besides, a device or a circuit which does not affect the primary function of the units can be inserted between two units shown to be in direct connection in the figures of the present invention. An embodiment or a claim of the present invention does not need to attain or include all the objectives, advantages or features described in the above. The abstract and the title are provided for assisting searches and not to be read as limitations to the scope of the present invention.

What is claimed is:

1. A rotation velocity sensor, comprising:
a driving unit, configured to operably generate a vibration driving signal in a predetermined frequency, and generate a reference signal in a same phase of the vibration driving signal;
a proof mass, configured to be operably driven by the vibration driving signal to vibrate in a first direction;
a rotation sensing element, configured to operably sense a vibration of the proof mass to generate a charge signal which corresponds to a portion of the vibration of the proof mass in a second direction orthogonal to the first direction;
a compensating unit, configured to operably generate a compensation signal according to the reference signal; and
a rotation sensing unit, configured to operably convert the charge signal to a voltage signal or a current signal, and compensate the voltage signal or the current signal according to the compensation signal to cancel a noise in the second direction so as to obtain a compensated rotation sensing signal.

2. The rotation velocity sensor of claim 1, wherein the charge signal includes information about a rotation of the sensor and a quadrature error, and at least a portion of the quadrature error is canceled in the compensated rotation sensing signal.

3. The rotation velocity sensor of claim 1, wherein the reference signal is related to the vibration driving signal.

4. The rotation velocity sensor of claim 1, wherein the compensating unit is configured to operably generate the compensation signal according to the reference signal and a disturbance detection signal, wherein the disturbance detection signal indicates a noise other than a quadrature error.

5. The rotation velocity sensor of claim 1, wherein the rotation sensing unit includes:
a charge-to-voltage (C/V) or a charge-to-current (C/I) converter, configured to operably convert the charge signal to the voltage signal or the current signal;
a compensation operator, configured to operably compensate the voltage signal or the current signal by the compensation signal to generate a compensated voltage or current signal; and
a demodulator, configured to operably demodulate the compensated voltage or current signal to generate a demodulated signal.

6. The rotation velocity sensor of claim 5, wherein the compensation operator compensates the voltage signal or the current signal by the compensation signal by an addition or subtraction operation.

7. The rotation velocity sensor of claim 5, wherein the compensating unit further adjusts a conversion ratio of the C/V or C/I converter.

8. The rotation velocity sensor of claim 5, wherein the rotation sensing unit further includes:
an amplifier coupled between the compensation operator and the demodulator, for amplifying the compensated voltage or current signal by a gain.

9. The rotation velocity sensor of claim 8, wherein the compensating unit further adjusts the gain of the amplifier.

10. The rotation velocity sensor of claim 5, wherein the rotation sensing unit further includes:
a filter for filtering the demodulated signal.

11. The rotation velocity sensor of claim 5, wherein the rotation sensing unit outputs the compensated rotation sensing signal in an analog or a digital form.

12. The rotation velocity sensor of claim 1, wherein each of the reference signal, the compensation signal, the charge signal, the voltage signal or the current signal, and the compensated rotation sensing signal includes a pair of differential signals.

13. The rotation velocity sensor of claim 12, wherein the differential signals of the charge signal are separately converted to the differential signals of the voltage signal or the current signal, and separately compensated by the differential signals of the compensation signal.

14. A method for sensing a rotation velocity, comprising:
driving a proof mass by a vibration driving signal such that the proof mass vibrates in a first direction;
sensing a vibration of the proof mass to generate a charge signal which corresponds to a portion of the vibration of the proof mass in a second direction orthogonal to the first direction;
generating a compensation signal according to the vibration driving signal;
converting the charge signal to a voltage signal or a current signal; and
compensating the voltage signal or the current signal according to the compensation signal to cancel a noise in the second direction so as to obtain a compensated rotation sensing signal.

15. The method of claim 14, wherein the step of generating a compensation signal according to the vibration driving signal generates the compensation signal according to the reference signal and a disturbance detection signal, wherein the disturbance detection signal indicates a noise other than a quadrature error.

16. The method of claim 14, wherein the step of compensating the voltage signal or the current signal according to the compensation signal includes:
compensating the voltage signal or the current signal by the compensation signal by an addition or subtraction operation.

17. The method of claim 14, further comprising:
adjusting a conversion ratio of the charge to voltage or charge to current conversion.

18. The method of claim 14, wherein the step of compensating the voltage signal or the current signal according to the compensation signal includes:
amplifying the voltage signal or the current signal by a gain; and
adjusting the gain.
